(19) United States
(12) Patent Application Publication
(10) Pub. No.: US 2016/0037261 A1
(43) Pub. Date: Feb. 4, 2016

(54) Composite Back Plate And Method Of Manufacturing The Same

(71) Applicant: Knowles Electronics, LLC, Itasca, IL (US)

(72) Inventor: Brandon Harrington, Chicago, IL (US)

(21) Appl. No.: 14/792,838

(22) Filed: Jul. 7, 2015

Related U.S. Application Data
(60) Provisional application No. 62/030,315, filed on Jul. 29, 2014.

(51) Int. Cl. H04R 7/04; B32B 9/04

(52) U.S. Cl. CPC H04R 7/04; B32B 9/04; B32B 2255/205; H04R 2201/003

(57) ABSTRACT

A back plate for use in a microphone includes a first layer; a second layer; and a metal layer disposed between the first layer and the second layer. A first compression of the back plate provided by cooling of the first layer and the second layer. A second compression of the back plate that is in addition to the first compression, the second compression being provided by the metal layer, the first and second compressions being effective to strengthen the back plate.

### CROSS REFERENCE TO RELATED APPLICATION

This patent claims benefit under 35 U.S.C. §119 (e) to U.S. Provisional Application No. 62030315 entitled “Composite Back Plate and Method of Manufacturing the Same” filed Jul. 29, 2014, the content of which is incorporated herein by reference in its entirety.

### TECHNICAL FIELD

This application relates to back plates and, more specifically, to the construction of these back plates.

### BACKGROUND OF THE INVENTION

Various types of microphones and receivers have been used through the years. In these devices, different electrical components are housed together within a housing or assembly. Other types of acoustic devices may include other types of components. These devices may be used in hearing instruments such as hearing aids, personal audio headsets, or in other electronic devices such as cellular phones and computers.

Acoustic microphones are used in today's marketplace. One type of microphone is a micro electro mechanical system (MEMS) microphone. The MEMS microphone uses a MEMs die that supports a diaphragm and a back plate. When the diaphragm moves my changing sound pressure the electrical potential between the microphone and the back plate changes to produce an electrical signal that is representative of the scanned sound.

As mentioned, these approaches used a back plate. The back plate can become brittle or break undo various circumstances. For example, if the device is dropped the back plate may crack. Large temperature or pressure swings can also result in damage to the back plate. If the back plate becomes damaged, the device may not operate properly or at all.

These problems have created general user dissatisfaction with previous approaches.

### BRIEF DESCRIPTION OF THE DRAWINGS

For a more complete understanding of the disclosure, reference should be made to the following detailed description and accompanying drawings wherein:

FIG. 1 comprises a perspective view of a back plate apparatus according to various embodiments of the present invention;

FIG. 2 comprises a perspective view of a microphone apparatus that utilizes the back plate apparatus of FIG. 1 according to various embodiments of the present invention;

FIG. 3 comprises a flow chart of one approach for manufacturing a back plate apparatus according to various embodiments of the present invention;

FIG. 4 comprises a block diagram of one example of constructing a strengthened back plate apparatus according to various embodiments of the present invention;

FIG. 5 comprises a diagram showing the compressive forces utilized in the construction of the back plate apparatus according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

While this invention is susceptible of embodiment in many different forms, there is shown in the drawings and will herein be described in detail a preferred embodiment of the invention with the understanding that the present disclosure is to be considered as an exemplification of the principles of the invention and is not intended to limit the broad aspect of the invention to the embodiment illustrated.

In the approaches described herein, a strengthened back plate is provided and a method for constructing or manufacturing this back plate is also described. The approaches described herein provide a strengthened back plate that is easy to produce but is much less susceptible to damage than previous approaches. As a result, user satisfaction with the devices that utilize the back plates (e.g., microelectromechanical system (MEMS) microphones) is enhanced.

In many of these embodiments, a back plate is constructed of appropriate materials (e.g., silicon nitride). Different layers of these materials are used. Between these layers, a metal intermediate layer is disposed or added. For example, this metal layer may be added by one etch of fluorine gas (e.g., tungsten or another refractory metal) with high compression stress to act as a strengthener. The intermediate layer also can act as a pathway to stress engineering the back plate through the thickness control of the additional metal. As a result and in one example, extremely high levels of air burst loading can be withstood by the device.

In many of these embodiments, a back plate for use in a microphone includes a first layer, a second layer, and a metal layer disposed between the first layer and the second layer. A first compression of the back plate is provided by cooling of the first layer and the second layer. A second compression of the back plate that is in addition to the first compression is also provided. The second compression is provided by the metal layer. The first and second compressions are effective to strengthen the back plate.

In some aspects, the first layer and the second layer are constructed of silicon nitride. In other aspects, the metal layer is constructed of refractory metal. Other examples are possible.

In other aspects, the metal layer comprises tungsten. In some examples, the metal layer is Germanium or Poly-silicon with higher thermal expansion coefficient (Tc) than silicon nitride.

In other examples, a thickness of metal layer is selected according to the thermal expansion coefficient (Tc) of the metal layer, the greater the Tc, the thinner a material layer.

In others of these embodiments, the above-mentioned back plate is used in a microphone.

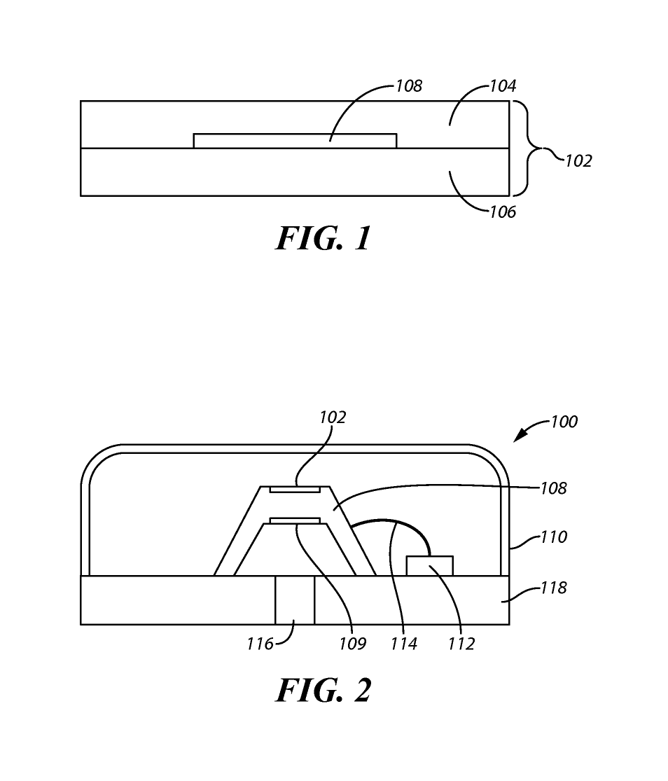

Referring now to FIG. 1, one example of a back plate with strengthener is described. The back plate 102 includes a first layer 104 and a second layer 106. A metal bar 108 is placed between the layers 104 and 106. Although two layers of non-metals are shown, it will be understood that other additional layers could also be deployed.

In one example, the layers 104 and 106 and constructed of silicon nitride (SiNi). Other examples of materials may be used to construct the layers 104 and 106.

In one example, the metal layer 108 is constructed of tungsten or another refractory metal added by an etch of fluorine gas. The metal layer can also be Germanium, Poly-silicon, or another material with higher thermal expansion coefficient (Tc) than silicon nitride. The greater the Tc, the thinner a material layer can be used. Other examples of metals may also be used.

Referring now to FIG. 2, the back plate 102 is shown being disposed within a microphone 100. More specifically, the back plate 102 is disposed at a MEMS die 108 with a diaphragm 104.

The MEMS die 108 is disposed on a substrate 118. An application specific integrated circuit (ASIC) 112 also disposed on the substrate 118. Wires 114 couple the MEMS die to the ASIC 112. A port or opening 116 extends through the substrate 118. A cover 110 enclosed the MEMS die 108 and the ASIC 112.

It will be appreciated that the microphone 100 is a bottom port device. However, the port can be disposed through the lid 110 (making the microphone a top port device) with all components still disposed on the base 118. Additionally, the microphone 100 could assume a MEMS-on-lid configuration where the MEMS die 108 is disposed on the lid 110. In this case, the ASIC 112 may still be disposed on the base 118, but in some examples may also be disposed on the lid 110.

In one example of the operation of the microphone 100, sound energy is received at the port 116. This sound energy moves the diaphragm 104 with which the back plate 102 creates an electrical signal. The electrical signal may be processed by the ASIC 112 and transmitted to pads (not shown) on the substrate 118. The pads may couple to user devices (e.g., electronic devices within a personal computer or cellular phone).

Since the back plate 102 has been strengthened by the processes described herein, when harsh forces impact the back plate 102, the back plate will not become damaged or break. In one example, extremely high levels of air burst loading can be withstood by the back plate 102.

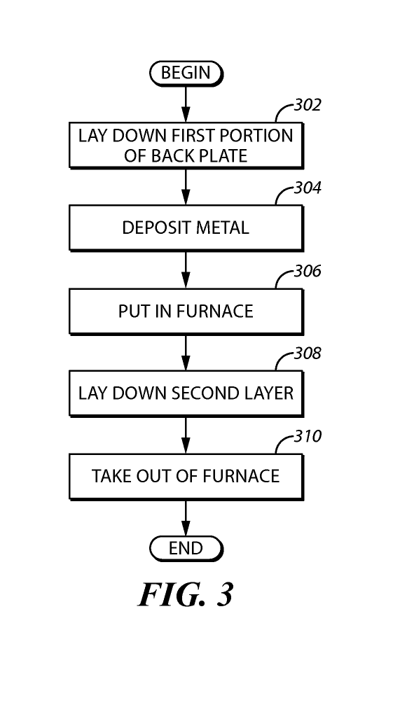

Referring now to FIG. 3, one example of a process of making the back plate is described. At step 302, a first portion of the back plate is laid down. This step may include the laying down of the first silicon nitride layer.

At step 304, a metal layer is deposited on the first layer. In one aspect, the metal layer is constructed of tungsten or another refractory metal added by an etch of fluorine gas. Other examples of metals may also be used.

At step 306, the back plate is put in a furnace and heated at an appropriate temperature such as 800 degrees C. (i.e., the deposition temperature of silicon nitride).

At step 308, a second layer is laid down over the metal layer and the first layer. This step may include the laying down of the second silicon nitride layer.

At step 310, the back plate is taken out of the furnace. At this point in time, the metal compresses. This compression of the metal in turn compresses the back plate and makes it stronger.

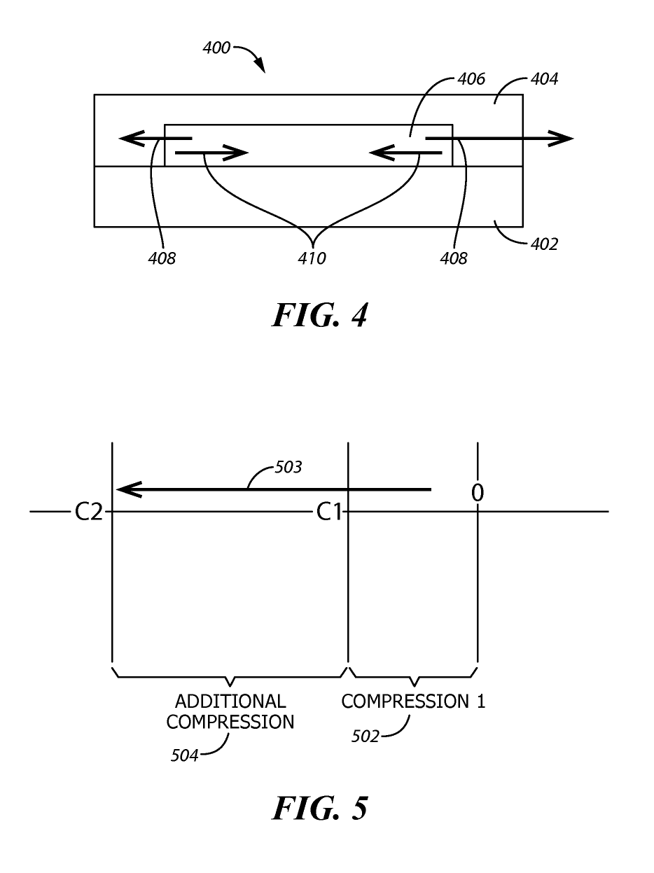

Referring now to FIG. 4, one example of the compression process is described. A back plate 400 includes a first layer 402, a second layer 404, and a metal layer 406.

Upon heating metal expands in direction indicated by the arrows labeled 408. Upon cooling, metal contracts in the direction indicated by the arrows labeled 410.

The thermal coefficient for the metal is much greater than the thermal coefficient for silicon nitride. The metal contracts more than the silicon nitride thereby compressing and strengthening the silicon nitride.

Referring now to FIG. 5, one example of the compression aspects of the present approaches is described. As shown, a first compression 502 (in the direction indicated by the arrow labeled 503) is provided by the silicon nitride during cooling. However, a second and additional compression 504 (also in the direction indicated by the arrow labeled 503) is provided by the cooling metal.

As a result of this second compression of the metal, the metal provides additional strength to the back plate. As mentioned, the thermal coefficient for the metal is much greater than the thermal coefficient for silicon nitride. As such, the metal contracts more than the silicon nitride thereby compressing and strengthening the silicon nitride.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A back plate for use in a microphone, the back plate comprising:
a first layer;
a second layer;
a metal layer disposed between the first layer and the second layer;
a first compression of the back plate provided by cooling of the first layer and the second layer;
a second compression of the back plate that is in addition to the first compression, the second compression being provided by the metal layer, the first and second compressions being effective to strengthen the back plate.

2. The back plate of claim 1, wherein the first layer and the second layer are constructed of silicon nitride.

3. The back plate of claim 1, wherein the metal layer is constructed of refractory metal.

4. The back plate of claim 1, wherein the metal layer comprises tungsten.

5. The back plate of claim 1, wherein the metal layer is Germanium or Poly-silicon with higher thermal expansion coefficient (Tc) than silicon nitride.

6. The back plate of claim 1, wherein a thickness of metal layer is selected according to the thermal expansion coefficient (Tc) of the metal layer, the greater the Tc, the thinner a material layer.

7. A microphone, comprising:
a base;
a micro electro mechanical system (MEMS) device disposed on the base, the MEMS device including a diaphragm and back the back plate comprising:
a first layer;
a second layer;
a metal layer disposed between the first layer and the second layer;
a first compression of the back plate provided by cooling of the first layer and the second layer;
a second compression of the back plate that is in addition to the first compression, the second compression being provided by the metal layer, the first and second compressions being effective to strengthen the back plate.

8. The microphone of claim 7, wherein the first layer and the second layer are constructed of silicon nitride.

9. The microphone of claim 7, wherein the metal layer is constructed of refractory metal.

10. The microphone of claim 7, wherein the metal layer comprises tungsten.

11. The microphone of claim 7, wherein the metal layer is Germanium or Poly-silicon with higher thermal expansion coefficient (Tc) than silicon nitride.

12. The microphone of claim 7, wherein a thickness of metal layer is selected according to the thermal expansion coefficient (Tc) of the metal layer, the greater the Tc, the thinner a material layer.
